(19) United States
(12) Patent Application Publication
(10) Pub. No.: US 2024/0196821 A1
(43) Pub. Date: Jun. 20, 2024

(54) A System for Controlling and Managing Hydroponic or Similar Cultivations on Modular Shelves

(71) Applicant: ONO EXPONENTIAL FARMING S.R.L., Verona (IT)

(72) Inventor: Thomas Ambrosi, Verona (IT)

(21) Appl. No.: 18/042,264

(22) PCT Filed: Aug. 11, 2021
(86) PCT No.: PCT/IB2021/057403

§ 371 Date: Feb. 20, 2023

(30) Foreign Application Priority Data
Aug. 21, 2020 (IT) 102020000020326

(51) Int. Cl. A01G 31/06; A01G 9/14; A01G 9/24

(52) U.S. Cl. CPC A01G 31/06; A01G 9/143; A01G 9/249

(57) ABSTRACT

A system for controlling and managing hydroponic or similar cultivations positioned inside at least one modular shelf (20, 23) is described, comprising a plurality of modular spaces (A, B, C) each adapted to contain at least one tray (21) for containing vegetable crops and a light source (22) adapted to illuminate a tray for containing vegetable crops. Each modular space (A, B, C) is provided with support elements for the trays, vertically separated by predetermined distances. The trays (21) may be moved inside each shelf. The shelf (20, 23) comprises a modular space adapted to house a tray (21) inside which space a control and management station (26) operates, comprising sensors able to determine the biological parameters of the vegetable crops, and actuators (31) able to correct said biological parameters for bringing them back to predetermined growth values.

### FIELD OF APPLICATION

The present invention relates to a system for controlling and managing hydroponic cultivations located on modular shelves, otherwise known as vertical farming.

It is a control system comprising a control and management station located inside a series of modular shelves arranged adjacent to one another, in which various vegetable crops are arranged, contained in respective movement trays.

In such control and management station there are detection systems useful for checking the status of the cultivations in progress, i.e. able to diagnose the specific situation in which the vegetables are found and to establish any corrections to be applied to the nutrient elements.

The present invention is advantageously applied in the sector systems for controlling and managing modular structures with a vertical layout intended for hydroponic, aeroponic and aquaponic farming or other similar structures that require the controlled movement of crops, or the like.

### PRIOR ART

In the state of the art various methods are known for the aeroponic and hydroponic farming of plants or vegetables above ground, where the soil is replaced by a suitable substrate and one of such methods envisages the vegetables being individually inserted into relevant containers distributed inside trays placed on various levels of a modular structure, known as a vertical farm, so that the root system of each plant remains inserted in a relevant nutritional liquid composed of water enriched with the essential elements for normal mineral nutrition, or peat in the case of crops in soil, where the roots remain in the substrate to look for the nutrients inside the container containing the peat or coconut fibre periodically soaked in solution, or the vermiculite or other not necessarily inert substrates.

Such modular structures are generally composed of four uprights that enable the positioning of a plurality of shelves intended to contain said trays, adapted to form, together with the uprights, modular shelves having a substantially parallelepiped conformation.

Such modular structures contain equipment suitable for the containment and development of the vegetables inserted into the respective trays placed on the various levels of the respective structure, i.e. irrigation, lighting, ventilation and climate control systems and systems for the movement of the trays inside the structure or towards the loading/unloading stations.

Normally the hydroponic farming systems, even those arranged in vertical farms, are not able to effectively simulate the micro-climate suitable for each type of vegetable, as up to now no modular systems are envisaged to enable the plant development of the different plantations, particularly systems able to bring about the necessary modifications and corrections when necessary.

In particular, up to now, no systems are provided for the control, verification and possible automatic integration and correction of the development parameters, or even systems for the verification and modification of the arrangement of the various trays on the basis of different treatment areas, and it is therefore impossible to optimise the spaces during the development in height of the farmed vegetables.

All this has a negative effect on the development of the plants which actually remains limited in control, with the possibility that the cultivations do not develop correctly with a certain percentage of waste.

Furthermore, the absence of an assiduous system for verifying the vegetal development of the farmed plants means that the trays must be placed at the maximum distance envisaged for their complete development, with notable waste in terms of spaces between the various trays superposed on the same module, which initially, i.e. in the period subsequent to insemination, remain substantially empty.

### DESCRIPTION OF THE INVENTION

The present invention intends to make available a control and management system comprising a station for controlling and managing hydroponic cultivations on modular shelves, otherwise known as vertical farming, which is able to eliminate or at least reduce the drawbacks highlighted above.

The invention sets out in particular to provide a control and management station which is placed inside one of the modular shelves arranged adjacent to one another, so that the crops to be analysed contained in respective modular movement spaces can be transported there.

In such control and management station, there are detection systems using sensors which are useful for verifying the status of the cultivations in progress, in particular:
the leaf coverage, by means of cameras the information system compares images captured at different moments and detects the leaf expansion variations;
the height of the vegetable, by means of stereoscopic cameras the system detects height variations with respect to previous and saved moments;
colour analysis;
the collection of the residual nutrient solution in the trays and the analysis of the characteristic values (pH, oxygenation, electrical conductivity, etc.)

The information collected is handled by software included in the system which processes it by analysing the statuses with the expected ones with respect to a set of parameters taken from the typical growth curves, from the expected statuses of nutrient consumption detected by the data coming from the residual solution, if necessary compensating for any deficiencies with the integration of nutrients or whatever is required.

In this area actuators are also provided, which enable the nutrients to be brought into the tank and in aerial mode, whether they are in liquid or gaseous form.

The system according to the invention enables the trays containing the crops to be controlled and positioned at different distances from one another, by varying the vertical positioning pitch on the basis of the development of the vegetables, with distance increases by about 100 mm or even less vertically for better fragmentation and freedom of possible combinations.

This is obtained by exploiting the possibility to handle the cultivations during their growth according to certain but not rigid rules on exposure to light sources which are used to trigger photosynthesis or to trigger desired extensions or limitations of the stem of the plants.

Advantageously, the system according to the invention enables the various shelves to be assembled or designed, so as to create contiguous, modular and scalable growth environments, wherein every environment is separated from the outside and from other environments of the same type by insulating walls. Such environments can be placed in communication by a passage openable on command through which the crops are transitable on a tray.

Each of these environments can be handled in a differentiated way relation in to the internal environmental parameters. The temperature, humidity, gas concentration or other parameters according to requirements can be differentiated and personalised.

### ILLUSTRATION OF THE DRAWINGS

Further features and advantages of the invention will become apparent from reading the following description of an embodiment of the invention provided by way of non-limiting example, with the aid of the drawings illustrated in the appended tables of drawings, in which:

FIG. 1 represents a front schematic view highlighting a modular shelf in which trays and respective lighting elements placed on different levels are inserted;

FIGS. 2, 3 and 4 illustrate front schematic views of three different configurations in the management of the trays with the same amount of space;

FIG. 5 is a front schematic view of an example of vertical farm comprising three modular shelves each of which has diversified management areas based on different parameters established by the control and management station;

FIG. 6 represents a front schematic view of a possible control and management station according to the invention;

FIGS. 7 to 10 represent schematic views of a first carriage intended for dosing and introducing corrective nutrients into the trays of the controlled hydroponic crops;

FIGS. 11 to 15 represent schematic views of a second carriage external to the growth area intended for the quality analysis of the controlled vegetables, the mixing of the corrective components and their pumping into the hydroponic system.

### DESCRIPTION OF AN EMBODIMENT OF THE INVENTION

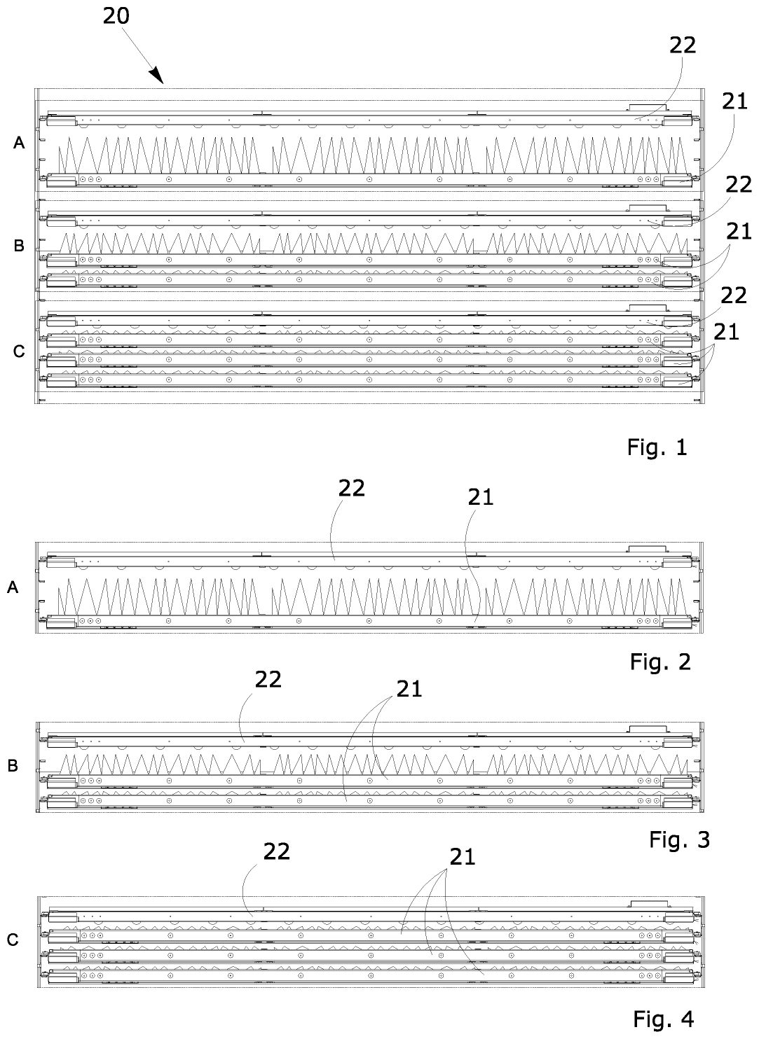

With reference to the appended figures, and initially in particular to FIG. 1, 20 denotes in its entirety a modular shelf comprising, in this case, three modular spaces A, B, C adapted to house a plurality of trays 21 alternating with a respective plurality of luminous bars 22, arranged on respective supports located at predefined distances.

The trays and the luminous bars are arranged on supports distanced in a standardised way from one another vertically, inside respective modular spaces A, B, C, and FIGS. 2, 3 and 4 represent different allocation configurations of the trays containing the crops.

Configuration A, which is better highlighted in FIG. 2, comprises a single tray 21 placed below a single luminous bar 22 and in this case the vegetables contained have reached the maximum development envisaged for that modular space.

Configuration B, which is better highlighted FIG. 3, comprises a pair of trays 21 placed below a single luminous bar 22 and in this case the lower tray comprises sprouted plants whereas in the upper one the vegetables contained have reached an intermediate development.

Configuration C, which is better highlighted in FIG. 4, comprises three single trays 21 placed below a single luminous bar 22 and in this case all three trays comprise sprouted plants, which require minimal space.

This system is made so as to be able to position the trays containing the crops at different distances from one another. The positioning pitch vertically can for example be about 100 mm but it could also be 50 mm or a different measurement for better fragmentation and freedom of possible combinations.

A vegetable grows over time according to generally sigmoid shaped curves and the initial sprouting step takes up much of the growth time. In this period the plant does not grow in height, the formation process of the stem and first leaves and the root system begins, and in this phase it does not occupy any space in height.

It is therefore possible to compact the trays on top of one another and to position them immediately below others or even position them exactly one step below the luminous bars for photosynthesis.

Once the germination period has finished, and thanks to the detection of the sensors connected to a control station, the trays are positioned at a suitable distance from the bottom of the other trays or from the luminous bars.

This system offers the possibility to handle the cultivations during their growth according to certain but not rigid rules on exposure to light sources which are used to trigger photosynthesis and different growth effects.

The movement possibility for the trays which can be positioned at different distances vertically, rather than in predetermined fixed positions typical of a classic rigid structure known in the state of the art enables the following main advantages to be obtained:
The trays can be positioned below different types of light sources with specialised emission according to the effects to be reached;
Unlike the normal indoor conditions under artificial light, where the trays are generally unmovable, or moved manually, and the lights are generally of only one type or of mixed type, in the system according to the invention there may be different light sources present in different positions inside a module. In the event in which LED luminous bars are used, it is envisaged that the lamps may have only one specific type of LED for each position and in this way the cost for the light sources decreases due to the lack of any other electronic light emission elements for the components;
The positioning at distances with a smaller pitch than the final height of the plant, with the lowest distance possible from the light sources, with net optimisation of the available spaces.

In normal indoor vertical farms the distance from the light sources is fixed for the entire growth time, from germination or straight after germination (if this takes place in specific rooms), until the end of growth. Therefore, from the first moment of exposure the lamps must emit the maximum number of photons to reach the leaves and trigger photosynthesis. The energy supply for obtaining such exposure is maximum right from the start.

On the contrary, the system according to the invention enables Lambert's law to be exploited, according to which with the same fluence (micro-moles to the leaf expressed in micro-Einstein) the energy input (electrical for LEDs) depends on the square of the distance. E=I/r² where “E” is the radiation or expected fluence, “I” the energy input, “r” the distance between the emitter (e.g. LED) and the radiated part (the leaves).

This means that as the trays can be moved closer to a correct distance from the lamps, during the growth phases, the energy saving is quadratic.

From the following table it is clear that in order to obtain the same fluence result at the leaf it is necessary to provide an energy factor sixteen times higher in the case of differences if the difference between position 1 and position 4 is compared:

| | r [m] | E [ue/m₂] | I [W] power | |
|---|---|---|---|---|
| Position | distance | fluence | input | |
| 1 | 0.1 | 2000 | 20 | dynamic |
| 2 | 0.2 | 2000 | 80 | dynamic |
| 3 | 0.3 | 2000 | 180 | dynamic |
| 4 | 0.4 | 2000 | 320 | VF - fixed |

During growth the system according to the invention envisages the possibility to move the plant towards or away from the light source in steps, thanks to the data detected by the control and management station, therefore dynamically following the need to radiate the leaf and saving on the energy input.

Therefore an adaptive and dynamic radiation system is obtained, which can be handled independently and automatically in indoor vertical farming, with the possibility to flexibly manage the plant according to the physiological needs, optimising its exposure to the light source as appropriate and managing the distance so as to also obtain notable energy savings.

It is to be noted that in the period in which the plants stay in the various positions according to the modular configurations B and C (FIGS. 3 and 4), below the illuminated trays it is possible to position other trays which at that time do not need light (night or dark phase), enabling the occupation of the crops in the volume to be optimised.

Another advantage is also obtained, i.e. that the CO₂ generated in the dark phase by the plants is used by the plants placed below the light source, generating a half-closed cycle that is partially self-powered.

This case also highlights the saving that occurs thanks to the fact that the lights are not switched off at the time when dark is necessary but there are simply no lamps to switch off, and the trays are moved into dark areas, e.g. below other trays, respecting the necessary spaces.

Therefore, fewer lamps are required with respect to a static vertical farm where the same number of light areas as the farming trays need to be installed, whereas in the system according to the invention, the quantity will always be lower. When dark is needed the lamps are not required, hence the saving in structural costs.

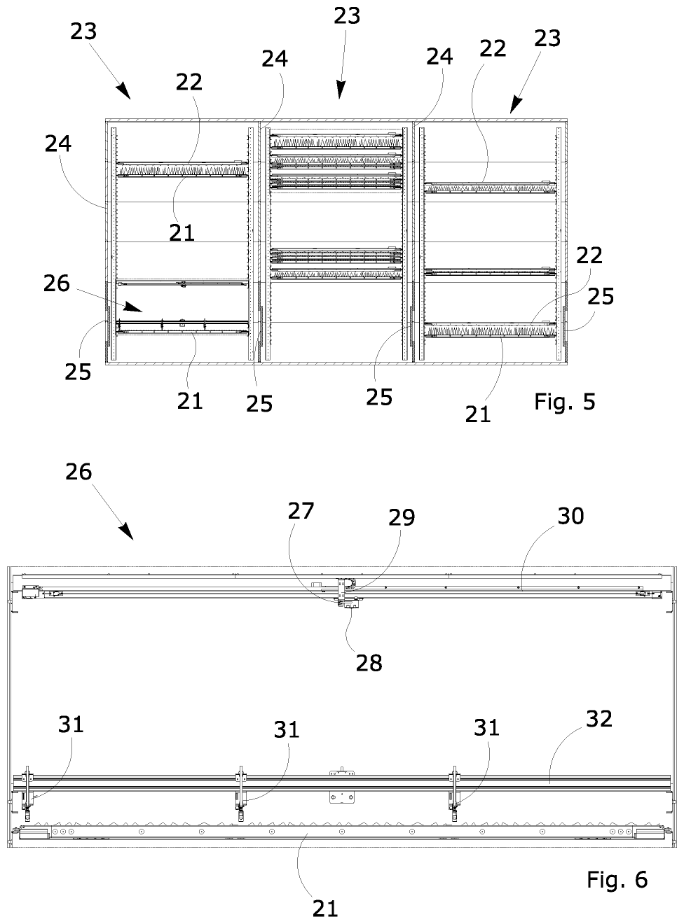

According to a particularly advantageous embodiment of the invention represented in FIG. 5, the modular shelves 23 that compose a vertical farm are constituted by contiguous, modular and scalable growth environments. That is, every modular shelf constitutes a growth environment and is separated from the outside and from other environments of the same type, physically by means of insulating walls 24.

It is envisaged that the various modular shelves 23 can be placed in communication with one another through passages 25, openable on command, through which it is possible to make the crops transit on a tray from one modular shelf to another.

Each of these environments can be handled in a differentiated way in relation to the internal environmental parameters. The temperature, humidity, gas concentration and all the aerial parameters inside each modular shelf 23 can be differentiated.

This system enables the crops to be moved from one environment to another during the time spent inside the modules, so as to obtain an improvement in the growth conditions and without the physical intervention of a human.

It is to be underlined that all this enables a management of the crops without “growth accelerators” which are not natural and intrinsic in the physiology of the plant.

All the technical peculiarities of the system according to the invention are oriented so as to follow as best as possible the natural growth of the plants according to their biological laws. By moving a tray from one climatic area to another it is therefore possible to follow the natural reactions of the vegetables so as to follow the generation of molecules for the growth, defence, strengthening and organoleptic and nutritional properties.

This dynamic condition which can be actuated by the system independently, as a function of the growth results detected with the dedicated sensors in the control areas, enables a dynamic period climate system to be exploited, with the possibility to assign different climatic moments to different crops during the period of their formation and growth in an adaptive or programmed way.

According to the invention, it is envisaged that for the management of the farming trays described above an area is provided inside a modular shelf, into which the crops contained in movement trays are taken for their analysis.

According to the embodiment illustrated in FIG. 6, such an area is defined by a control and management station 26 in which sensor control systems are located that are suitable for the detection of a status of the cultivations in progress. In particular:
the leaf coverage is analysed by means of cameras 27 connected to an information system which compares the images captured at different moments and detects the leaf expansion variations;
the height of the vegetable is detected by means of stereoscopic cameras 27 which measure height variations with respect to previous and saved moments;
the same cameras 27 also analyse the colour parameters.

The cameras 27 are combined with an aerial irrigation or spraying system 28, and the whole is placed on a carriage 29 which slides on a crosspiece 30 placed in the upper area of the station 26.

According to the embodiment of FIG. 6, the use of suitable actuators 31 is also envisaged, for the purpose of collecting the residual nutrient solution in the trays and of introducing new or integrative solution. Such actuators 31, placed on further respective carriages sliding on a crosspiece 32, send the samples to a sector for analysing the characteristic values such as the pH, oxygenation, electrical conductivity, or the like.

The information collected is handled by the software of the system which processes it by analysing the statuses with the expected ones with respect to a set of parameters taken from the typical growth curves, from the expected statuses of nutrient consumption detected by the data coming from the residual solution.

Once the data have been processed, the information system assesses the management of the continuation of the crop possibly varying the following parameters:
the concentration and mixture of nutrients to be sent into aqueous solution in the tanks present in the control and management station 26;
the amount of litres to be introduced in order to compensate for what is consumed.

It is also possible for the control and management station 26 to handle in a different way the subsequent positioning of the tray inside the modular shelves, assigning different lighting or distances.

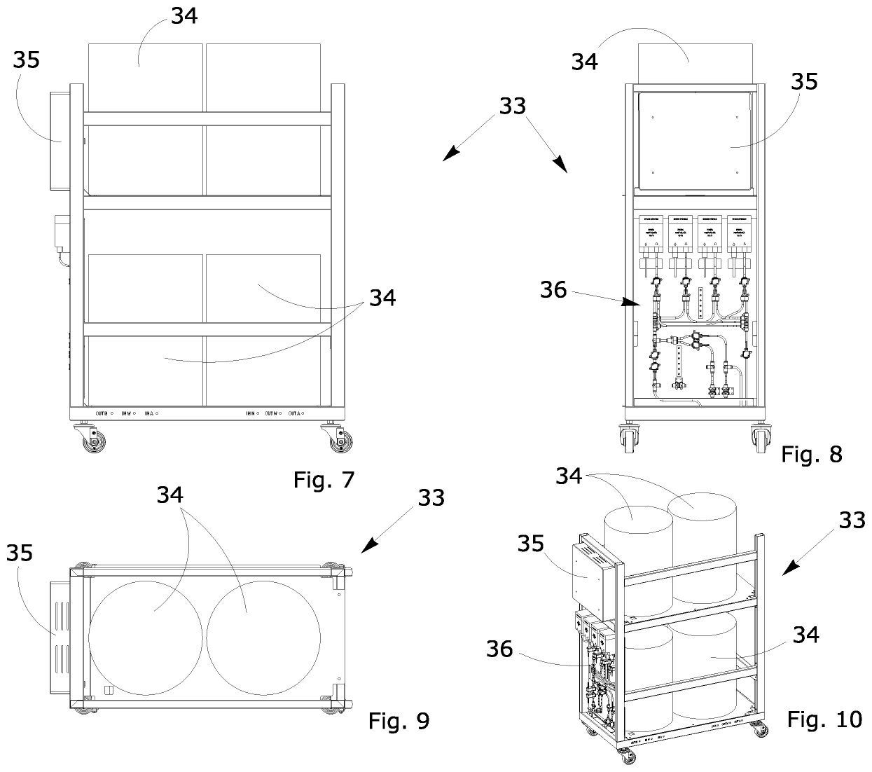

FIGS. 7 to 10 represent a first carriage 33 intended for dosing and introducing corrective nutrients in the trays of the controlled hydroponic crops.

It is possible to highlight in such carriage the presence of nutrient reservoirs 34, an electrical control panel 35 and a hydraulic dosing central control unit 36.

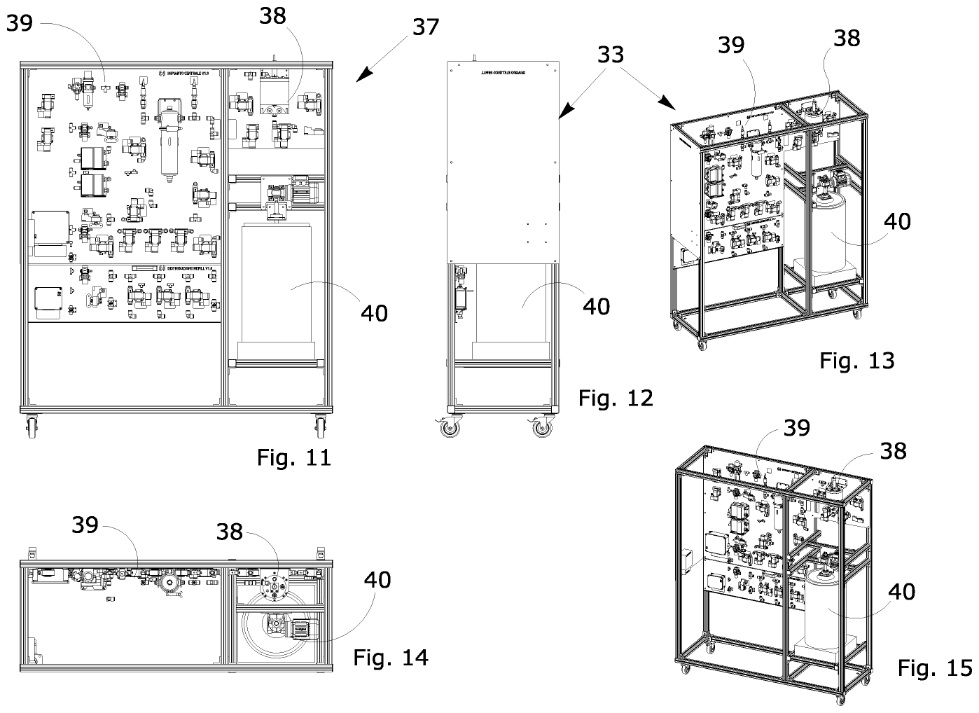

Finally, FIGS. 11 to 15 represent schematic views of a second carriage 37 intended for the quality analysis of the controlled residual nutrients, the mixing of the corrective components and their pumping into the hydroponic system.

In this case such a carriage 37 comprises a value analysis unit 38, a hydraulic pumping unit 39 and a mixing unit 40 of the corrective nutrients to be introduced into the trays of the controlled hydroponic crops.

The invention has been described in the foregoing with reference to a preferential embodiment thereof. However it is clear that the invention is susceptible to numerous variants which fall within the scope thereof, and which are technically equivalent.

1.-10. (canceled)

11. A system for controlling and managing hydroponic or similar cultivations positioned inside at least one modular shelf, wherein the modular shelf comprises a plurality of modular spaces each adapted to contain at least one tray for containing crops and a light source adapted to illuminate a tray for containing vegetable crops, each modular space being provided with support elements for the trays, vertically separated by predetermined distances, wherein the trays can be moved inside each modular shelf,
characterized in that said at least one modular shelf further comprises a modular space adapted to house a tray inside which space a control and management station operates, comprising sensors able to determine the biological parameters of the vegetable crops, and actuators able to correct said biological parameters for bringing them back to predetermined growth values.

12. The system according to claim 11, characterized in that it comprises a plurality of modular shelves arranged adjacent to one another and which each define a growth environment for vegetable crops, each environment being separated from the outside and from other environments of the same type, by insulating walls.

13. The system according to claim 12, characterized in that at least two of said modular shelves are placed in mutual communication by at least one passage, which can be opened or closed on command, through which the crops are transitable on a tray.

14. The system according to claim 13, characterized in that said at least one passage is arranged at the modular space inside which said control and management station operates.

15. The control system according to claim 12, characterized in that each environment is managed in a differentiated way in terms of the internal environmental parameters of temperature, humidity and gas concentration.

16. The control system according to claim 11, characterized in that the control and management station comprises sensors for the detection of the leaf coverage which is analyzed by means of cameras connected to an information system which is configured to compare the images captured at different moments containing information related to leaf expansion variations of the vegetable crops and to transmit such information to a further information system which is configured to compare the images captured at different moments, to detect the vegetative variations of the crops, and to set any corrective values.

17. The system according to claim 11, characterized in that the actuators are configured to collect samples of residual nutrient solution possibly present in a tray and to send the samples to a sector for the analysis of characteristic parameters.

18. The system according to claim 16, characterized in that the information collected inside the control and management station is handled by a control system software which is configured to compare the detected statuses with those expected with respect to a set of parameters taken from typical growth curves, and the expected nutrient consumption statuses detected from data coming from the residual solution.

19. The system according to claim 11, characterized in that it comprises a first carriage intended for dosing and introducing corrective nutrients in the trays of the controlled hydroponic crops, said carriage comprising nutrient reservoirs, an electrical control panel and a hydraulic dosing central control unit.

20. The control system according to claim 11, characterized in that it comprises a second carriage intended for the analysis of the quality of the controlled residual nutrients, for mixing the corrective components and for pumping them into the hydroponic system or soil-grown crops, or coconut fibre or vermiculite or the like, periodically soaked with solution, said carriage comprising a value analysis unit, a hydraulic pumping unit and a mixing unit of the corrective nutrients to be introduced into the trays of the controlled hydroponic crops.
